(19) United States
(12) Patent Application Publication
(10) Pub. No.: US 2024/0413299 A1
(43) Pub. Date: Dec. 12, 2024

(54) SOLID STATE BATTERY CONTAINING CONTINUOUS GLASS-CERAMIC ELECTROLYTE SEPARATOR AND PERFORATED SINTERED SOLID-STATE BATTERY CATHODE

(71) Applicant: Johnson IP Holding, LLC, Atlanta, GA (US)

(72) Inventors: Lonnie G. JOHNSON, Atlanta, GA (US); Lazbourne Alanzo Allie, McDonough, GA (US); Adrian M. Grant, Lawrenceville, GA (US); Devon Lyman, Roswell, GA (US); David Johnson, Douglasville, GA (US); Kenechukwu Nwabufoh, Austell, GA (US)

(21) Appl. No.: 18/804,313

(22) Filed: Aug. 14, 2024

Related U.S. Application Data
(63) Continuation of application No. 17/499,236, filed on Oct. 12, 2021, now abandoned.
(60) Provisional application No. 63/090,968, filed on Oct. 13, 2020.

(51) Int. Cl. H01M 4/131; H01M 4/04; H01M 4/134; H01M 4/1391; H01M 4/1395; H01M 4/38; H01M 4/505; H01M 4/525; H01M 10/0525; H01M 10/0562; H01M 10/0585; H01M 50/403; H01M 50/437

(52) U.S. Cl. CPC H01M 4/131; H01M 4/0409; H01M 4/0423; H01M 4/0433; H01M 4/0471; H01M 4/134; H01M 4/1391; H01M 4/1395; H01M 4/382; H01M 4/505; H01M 4/525; H01M 10/0525; H01M 10/0562; H01M 10/0585; H01M 50/403; H01M 50/437; H01M 2300/0071

(57) ABSTRACT

A solid-state battery cell is provided, which contains a sintered metal oxide cathode, in which a surface of the cathode has an array of cavities extending about 60-90% into a depth of the cathode; a glass or glass ceramic electrolyte separator forming a smooth layer on the cathode surface and extending into the depths of the cavities of the cathode; and a lithium-based anode in contact with the electrolyte on a side opposite the cathode. A method of making the solid-state battery cell is also described.

### CROSS-REFERENCE TO RELATED APPLICATIONS

This application is a continuation of co-pending U.S. patent application Ser. No. 17/499,236, filed Oct. 12, 2021, which claims priority to U.S. Provisional Patent Application No. 63/090,968 filed Oct. 13, 2020, the disclosures of which are herein incorporated by reference in their entireties.

### BACKGROUND OF THE INVENTION

Solid-state batteries are the focus of a great deal of attention because of the potential for attractive performance properties, including long shelf life, long term stable power capability, no gassing, broad operating temperature range (−40° C. to 170° C. for pure lithium anodes and up to and beyond 300° C. using active composite anodes), and high volumetric energy density (up to 2000 Wh/L). They are particularly suited for applications requiring long life under low-drain or open-circuit conditions.

Solid-state lithium batteries were developed by Duracell in the 1970s and made commercially available in the 1980s but are no longer produced. These cells included a lithium metal anode, a dispersed phase electrolyte of lithium iodide and Al₂O₃, and a metal salt as the cathode. The Li/LiI(Al₂O₃)/metal salt construction was a true solid-state battery and demonstrated very high energy densities of up to 1000 Wh/L and excellent performance in terms of safety, stability, and low self-discharges. However, the battery was not rechargeable, and due to the pressed powder construction and the requirement for a thick electrolyte separation layer, the cell impedance was very high, severely limiting the discharge rate of the battery. This type of cell is also restricted in application because the electrochemical window is limited to less than three volts due to the iodide ions in the electrolyte, which are oxidized above approximately three volts. In addition, a stable rechargeable version of this cell was never developed.

Currently, Li-ion battery chemistry using liquid electrolyte provides the best-known performance and is the most widely used of all battery chemistries. Lithium ion cells consist of thick (˜100 μm) porous composite cathodes cast on a thin (˜10 μm) Al foil current collector. The composite cathode typically contains both LiCoO₂ as the active material, due to its high capacity and good cycle life, and carbon black, which provides electrical conductivity throughout the layer. A thin polymer separator provides electrical isolation between the cathode and the carbon-based anode. The anode intercalates Li during the charge cycle. The cell is immersed in a liquid electrolyte, which provides very high conductivity for the transport of Li ions between the cathode and anode during charge and discharge. Because the separator and composite cathode and anode are all porous, the liquid electrolyte is absorbed into and fills the structure, thus providing excellent surface contact with the LiCoO₂ active material and allowing fast transport of Li ions throughout the cell with minimal impedance.

The liquid electrolyte itself consists of a Li salt (for example, LiPF₆) in a solvent blend which typically includes ethylene carbonate and other linear carbonates, such as dimethyl carbonate. Despite improvements in energy density and cycle life, there remain several underlying problems with batteries that contain liquid electrolytes. For example, liquid electrolytes are generally volatile and subject to pressure build up, explosion, and fire under a high charge rate, a high discharge rate, and/or internal short circuit conditions. Additionally, charging at a high rate can cause dendritic lithium growth on the surface of the anode. The resulting dendrites can extend through the separator and internally short circuit in the cell. Further, the self-discharge and efficiency of the cell is limited by side reactions and corrosion of the cathode by the liquid electrolyte. Still further, the liquid electrolyte also creates a hazard if the cell over-heats due to overvoltage or short circuit conditions, creating another potential fire or explosion hazard.

Additionally, because of the passivation reactions and unstable interfaces that form between organic electrolyte materials such as liquid and solid polymer electrolytes, it has long been a goal to develop a rechargeable solid-state lithium-based battery using an inorganic solid electrolyte material.

In the early 1990s, a second type of all-solid-state battery was developed at the Oak Ridge National Laboratories. These cells consisted of thin films of cathode, inorganic electrolyte, and anode materials deposited on a ceramic substrate using vacuum deposition techniques, including RF sputtering for the cathode and electrolyte and vacuum evaporation of the Li metal anode. The total thicknesses of the cells were typically less than 10 μm: the cathode had a thickness of less than 4 μm, the solid electrolyte a thickness of around 2 μm (just sufficient to provide electrical isolation of the cathode and anode) and the Li anode a thickness of around 2 μm. Since strong chemical bonding (both within each layer and between the layers of the cell) was provided by the physical vapor deposition technique, the transport properties of these cells were excellent. Although the solid electrolyte LiPON has a conductivity of only 2×10⁻⁶ S/cm⁻¹ (fifty times lower than that of the LiI(Al₂O₃) solid electrolyte used in the earlier Duracell battery), the impedance of the thin 2 μm layer was very small, allowing for very high-rate capability.

However, batteries based on this technology also have major limitations. The vacuum deposition equipment required to fabricate the cells is very expensive and the deposition rates are slow, leading to very high manufacturing costs. Also, in order to take advantage of the high energy density and power density afforded by use of the thin films, it is necessary to deposit the films on a substrate that is much thinner and lighter than the battery layers themselves so that the battery layers make up a significant portion of the volume and weight of the battery compared to the inert substrate and packaging components. Ideally, one would simply use thicker battery electrode layers and thereby make the substrate a less significant percentage of the battery's volume; however, it is not practical to increase the electrode thickness beyond a few microns. Low lithium diffusion rates coupled with thick electrode layers results in an impractical battery with low charge and discharge rates. Therefore, the films must be deposited on very thin substrates (<10μm) or multiple batteries must be built up on a single substrate, which leads to problems with maintaining low interface impedance with the electrolyte during the required high temperature annealing of the cathode material after deposition.

To create a solid-state battery with increased capacity and high energy density, high energy cathodes of approximately a magnitude of an order thicker (˜40 μm) than thin film (˜4 μm) cathodes is necessary. As a result, solid-state batteries that employ high-capacity lithium intercalation compounds are being developed. To gain access to a thicker layer of active material, a composite cathode with a compatible high conducting inorganic solid electrolyte and an electronic additive is necessary to facilitate the flow of lithium ions and electrons respectively, in such a thick cathode. Past attempts at constructing such all-solid-state batteries utilizing such a cathode have been limited by the need to bind the materials together in order to facilitate effective lithium-ion transport across interfaces. This binding process has been attempted by sintering at high temperature, such as 800° C. and higher. However, the cathode and electrolyte materials may react with each other at such sintering temperatures, resulting in high impedance interfaces and an ineffective battery.

To avoid the parasitic reaction problems associated with high temperature sintering, all solid-state batteries have been developed using a low temperature sol gel process. These all-solid-state batteries consist of a composite cathode containing active battery cathode material (e.g., LiNiMnCoO₂, LiCoO₂, LiMn₂O₄, Li₄Ti₅O₁₂ or similar), an electrically conductive material (e.g., carbon black), and lithium ion conductive glass electrolyte material, such as Li₃ₓLa_{2/3-x}TiO₃ (x=0.11) (LLTO) or Li₇La₃Zr₂O₁₂ (LLZO) that may be formed in situ from a liquid, organic precursor. When gelled and subsequently cured at low temperature, the precursor is transformed into a solid lithium ion conductive glass electrolyte.

In constructing a solid-state battery using the low temperature sol gel approach, a cathode may be formed by mixing a lithium active material, an electrically conductive material, and the liquid sol gel precursor to form a homogenous mixture or paste. The cathode may be formed as either a thick pellet or as a thin casting containing the mixture of cathode components. The cathode is held together by the ion conductive glass electrolyte matrix that is formed by gelling and curing the sol-gel precursor solution. Curing temperature for the gelled precursor is in the range of 300° C., thus avoiding parasitic reactions.

However, construction of battery electrodes using the sol gel approach to produce glass electrolyte as a binder requires proper gelling, drying, and curing of the precursor. Gelling of precursors for LLTO and LLZO is a hygroscopic process. Moisture must diffuse into the cathode structure through the tortuous path formed by the densely packed cathode powder materials in order for the cathode material to gel properly throughout. Drying of the precursor after gelling may be time consuming because solvents and alcohols must diffuse through the gelled electrolyte within the tortuous compacted electrode powder structure.

Metal oxide electrolytes having conductivities in the range of 10⁻³ S/cm have been fabricated. However, the use of such materials as solid electrolytes in all-solid-state batteries has been limited, in part due to the high interface impedance that results from the high temperature sintering process used to form bonds between the electrolyte and active cathode materials. While bonding is needed to enable lithium ion conduction between the materials, inter-atomic migration during sintering results in very high interface impedance and very limited functionality of a resulting cell.

Even though solid-state batteries have been made by homogenous mixtures of electrolyte and active material powders and bonded together using low temperature processing to yield low interface impedance, improved charge/discharge rate capability and access to the full capacity of thicker cathodes has remained very limited. FIG. 1 shows the various layers of a prior art solid-state cell, including cathode current collector 8, cathode 6, electrolyte separator 4 and anode layer 2 constructed using the prior state of the art approach. In the expanded view, solid electrolyte particles 12 are shown embedded within cathode active material 10.

Cathode 6 is constructed having enough solid electrolyte material 12 to achieve percolation such that there is a network of particles in contact with each other to achieve ionic conduction continuity. The standard construction procedure for the cathode is to mix the constituent cathode powder materials until the electrolyte particles are relatively homogenously distributed. The relatively uniform, but random, distribution is maintained during construction of the battery cell such that the configuration shown in FIG. 1 is representative of a completed battery in accordance with the prior art. It illustrates some of challenges faced with constructing solid-state cells, particularly those with relatively thick cathodes. Because of the random mixing process, some percentage of the electrolyte material, particles and group of particles, will naturally be surrounded by active cathode material and thereby isolated from the electrolyte network, as illustrated by particles 14. These isolated particles cannot participate in transporting lithium ions into the cathode. For example, consider lithium ion 22 conducted through electrolyte separator layer 4. It continues a conductive path through electrolyte particle 24. It receives an electron 20 and transition into active material 10. After receiving an electron and returning to its full lithium state 26, it is intercalated by and diffuses into the cathode material 10. It is expected to not release its electron in order to enter electrolyte particle 25 so that it can be conducted deeper into the cathode while its electron is conducted via a parallel path 28 so that it is reconstituted at lithium at 30. Once intercalated as lithium into the active cathode material, its transport within the cathode will be by diffusion, which is too slow for most applications.

Another problem is the limited cross-sectional area where electrolyte particle connects to each other as represented at 15. These areas of limited interface are like conduction choke points. They tend to cause increased impedance due to the small contact areas between particles.

Still another problem is represented by network of particles 16. Ideally, lithium ion 17 enters the network, is conducted through a series of interconnected particles, receives an electron 18, and is intercalated into active material 10 at location 19. This is a tortuous path that is made worse by the fact that the ion must often be conducted in a direction opposite that of the electronic charge field to be intercalated at 19. It is not clear that this would occur, given the positive charge of the lithium ion.

The net effect of the problems presented by a cathode with a random distribution of conductive electrolyte particles limits the performance of solid-state batteries. Therefore, a need remains for a solid-state cell structure that provides high-rate capability and effective transport of lithium within the structure of the resident electrode.

FIG. 2 shows test and modeling data for a prior art cell having a configuration such as that that shown in FIG. 1 according to the prior art. It illustrates the relationship between volumetric energy density, cathode thickness and percent active material contained within the cathode relative to the amount of inactive material i.e., the amount of electrolyte and electronic additive. As the cathode increases in thickness, the current collector, which is passive (it contributes to volume and thickness but not storage capacity), retains the same thickness. Achieving useful discharge rates is a challenge with the configuration illustrated in FIG. 1 as described previously. Higher active material loading results in concentration polarization because of limited electrolyte continuity and low ionic active component (lithium) diffusion rates within the active material.

### BRIEF SUMMARY OF THE INVENTION

In one embodiment of the disclosure, a solid-state battery cell comprises: a sintered metal oxide cathode, wherein a surface of the cathode has an array of cavities extending about 60-90% into a depth of the cathode; a glass or glass ceramic electrolyte separator forming a smooth layer on the cathode surface and extending into the depths of the cavities of the cathode; and a lithium-based anode, wherein the anode is in contact with the electrolyte on a side opposite the cathode.

In another embodiment, the disclosure provides a solid-state battery cell comprising a non-homogeneous mixture of cathode active material and glass or glass ceramic electrolyte material, wherein a continuous electrolyte separator extends into cavities of a patterned cathode, providing high surface area interface.

In a further embodiment of the disclosure, a method for making a solid-state battery cell comprises:
(a) providing a cathode slurry comprising a cathode active material, a binder, and a solvent;
(b) slurry casing the cathode slurry onto a non-stick substrate to form a green ceramic cathode material;
(c) printing a pattern into a surface of the cathode to produce cavities in the surface;
(d) sintering the patterned cathode to form a solid ceramic cathode;
(e) coating the printed surface of the cathode with a layer of molten glass or glass ceramic electrolyte; and
(f) quenching the molten glass or glass ceramic electrolyte to form a dense cathode-separator composite structure comprising a continuous separator extending into the cavities of the patterned cathode.

### BRIEF DESCRIPTION OF THE SEVERAL VIEWS OF THE DRAWINGS

The following detailed description of preferred embodiments of the present invention will be better understood when read in conjunction with the appended drawing. For the purposes of illustrating the invention, there are shown in the drawings embodiments which are presently preferred. It is understood, however, that the invention is not limited to the precise arrangements and instrumentalities shown. In the drawings:

FIG. 1 is a diagram of a prior art solid-state cell;

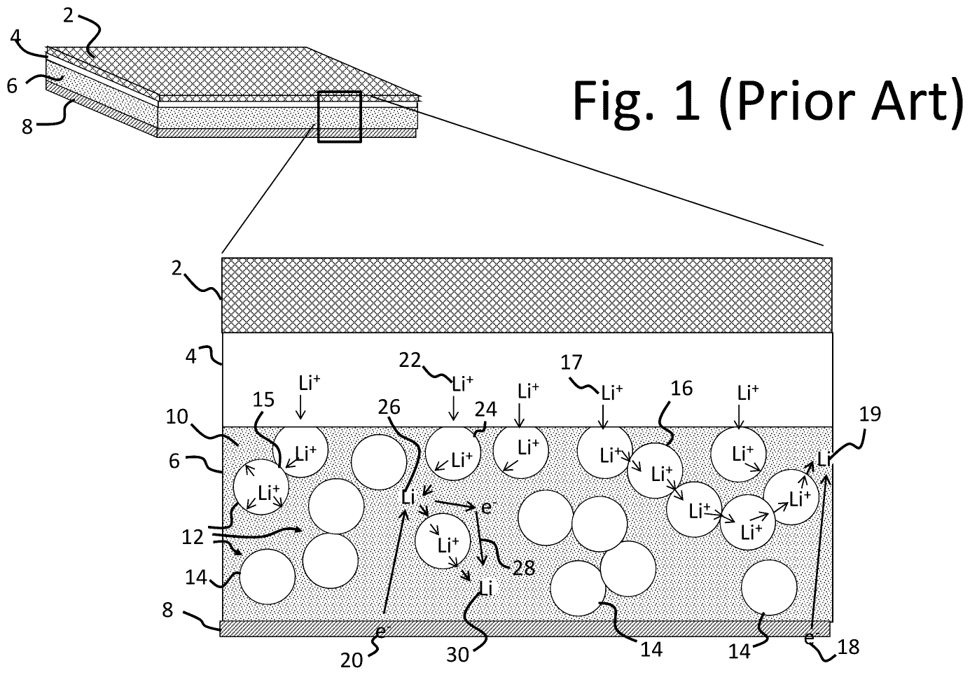

FIG. 2 is a graph of battery performance of a prior art solid-state battery;

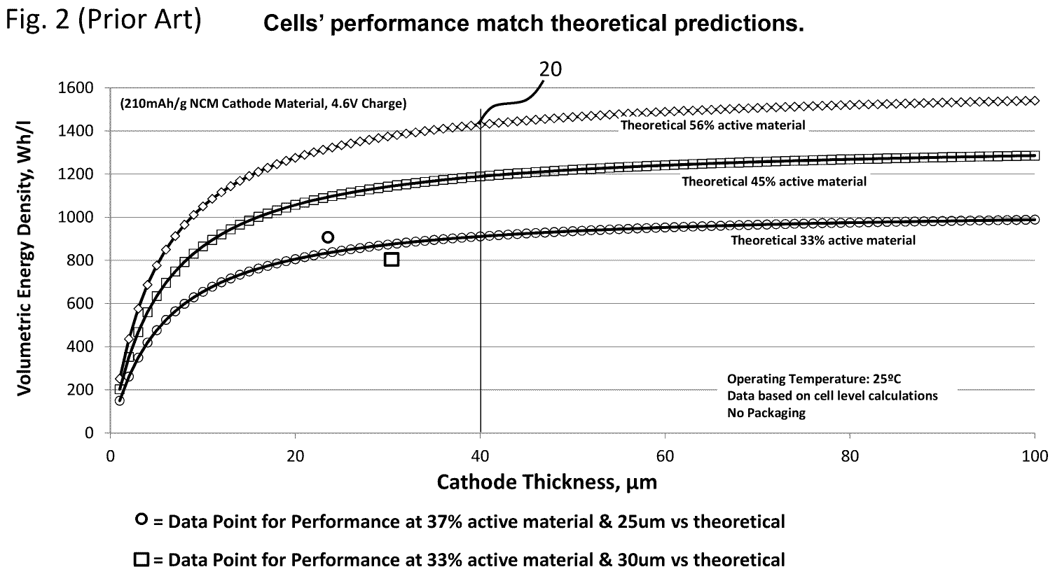

FIG. 3 is a diagram of a die used to form cavities in a cathode according to embodiments of the disclosure;

FIG. 4 is a diagram of a die used to form cavities in a cathode according to embodiments of the disclosure;

FIG. 5 is a diagram of a roller used to apply an electrolyte to a cathode according to embodiments of the disclosure;

FIG. 6 is a diagram of molten electrolyte flowing into a cathode according to embodiments of the disclosure;

FIG. 7 is a cross section of a solid-state battery cell according to embodiments of the disclosure;

FIG. 8 is a close-up diagram of a cathode cavity filled with electrolyte according to embodiments of the disclosure;

FIG. 9 is an arrangement of cavities in the cathode according to embodiments of the disclosure; and

FIG. 10 is an optical microscope image of a perforated cathode according to an embodiment of the disclosure

### DETAILED DESCRIPTION OF THE INVENTION

Embodiments of the disclosure relate to an all inorganic solid-state battery cell having thick lithium active electrodes relative to the thickness of the inert components, and which exhibits high “C” rate capability, where “C” is defined as the Amp-hour capacity of the battery divided by discharge current. Such a solid-state battery addresses the need for improved lithium ion transport within solid-state battery electrodes by providing a non-homogenous mixture of electrode active material and electrolyte material in which a cost-effective continuous electrolyte separator material extends to a substantial depth into the surface of a patterned cathode providing high surface area interface. It addresses the need for reduced tortuous conduction paths, eliminates conduction choke points, and provides an effective voltage field gradient to promote or motivate migration of ions through the electrolyte deeper into the electrode. As described in more detail below, the desired cathode structure may be formed by slurry casting a green ceramic material followed by die or roll stamping a desired pattern into its surface. However, it may also be formed by 3D printing green ceramic cathode material or other suitable technique. The cathode structure is then sintered at high temperature and coated with a glass electrolyte using a melt quench process.

### Cathode Structure and Preparation

The electrochemically active material used to form the cathode structure is preferably an inorganic lithium-based metal oxide ceramic material, such as, without limitation, lithium nickel manganese cobalt oxide (NCM), lithium titanium oxide (LTO), Lithium Nickel Oxide (LNO), lithium cobalt oxide (LCO), or lithium manganese oxide (LMO); the most preferred is NCM. Other lithium-based electrochemically active materials known in the art or to be developed are also within the scope of the disclosure. The particle size of the electrochemically active material is preferably less than about 5 μm, more preferably less than about 1 μm, depending on the application of the battery. The active material selected for inclusion in a given electrode may be selected based on the desired operating voltage and capacity.

In one embodiment, a powder of the selected electrochemically active cathode material is mixed with a polymer binder, such as polyvinyl difluoride, polyvinyl alcohol, or polyvinyl butyral, and a solvent, such as acetone, xylene, or ethanol, to form a precursor cathode tape casting material. Alternatively, a powder of the selected electrochemically active cathode material may be mixed with a solvent, such as acetone, xylene, or ethanol, to form a precursor cathode tape casting material. The resulting precursor cathode tape is doctor blade cast, extruded, or formed by other suitable means onto a non-stick substrate such as silicone coated mylar or teflon, into a planar structure of a desired thickness and allowed to dry by solvent evaporation at room or elevated temperature. The casting is subsequently calendared to densify using a press or compression rollers to yield a green cathode preform having a thickness of about 10 to 200 μm.

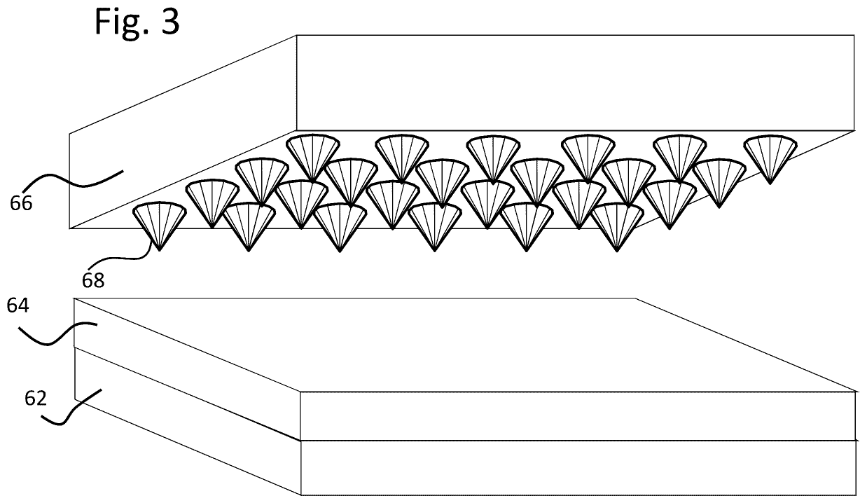

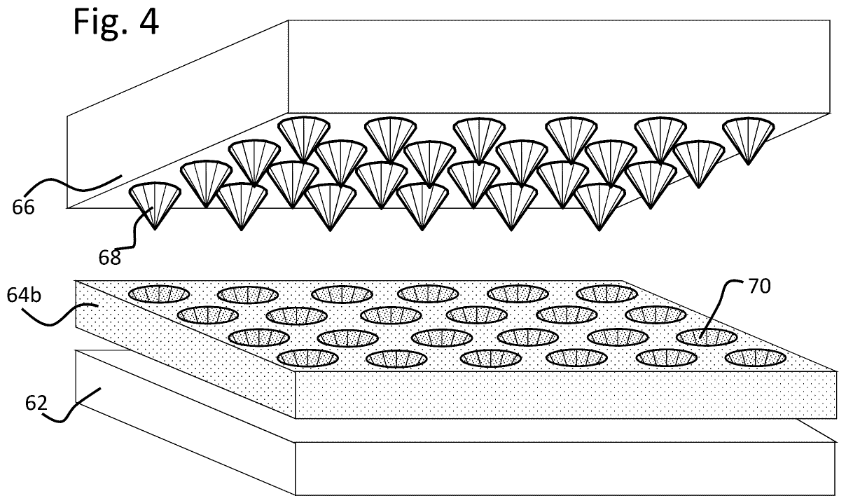

FIG. 3 shows substrate/mechanical support 62, a preformed green cathode casting 64 and patterning die 66 which can also serve the purpose of densifying the cathode. Die 66 may be micro-machined into a desired configuration using electrochemical etching or other suitable techniques and may be micro-machined onto the surface of the press or compression rollers used for densification of the cathode, as described above. When pressed into the green cathode material 64, protrusions 68 create cavities in the cathode material. FIG. 4 illustrates a resulting pattern of cavities 70 in material 64 after the die 66 is removed. While only one shape is illustrated, the cavities may be of any shape, such as, but not limited to conical, triangular, semi-circular, rectangular, etc. The depth of the cavities is preferably a substantial depth of the thickness of the cathode, such as about 60-95% of the thickness of the cathode. The distance between the cavities on the surface of the cathode can be about 5 μm to about 1000 μm, preferably about 5 μm to about 50 μm.

Once cathode 64b is formed, if a binder is present, it is heated to about 300° C. to 450° C. to remove the binder; in all cases it is sintered at a temperature of about 500° C. to about 900° C., preferably about 850° C., to form a solid ceramic structure.

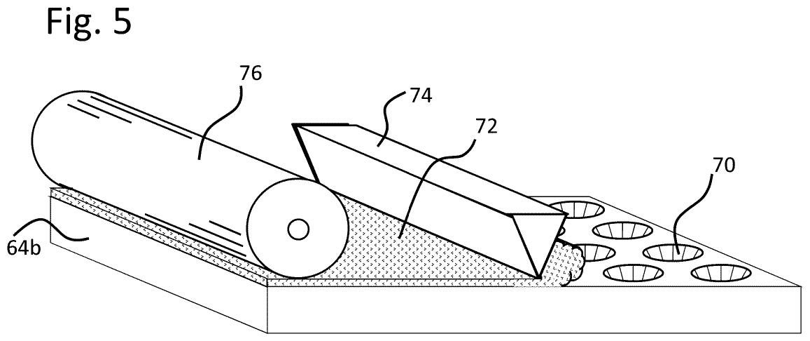

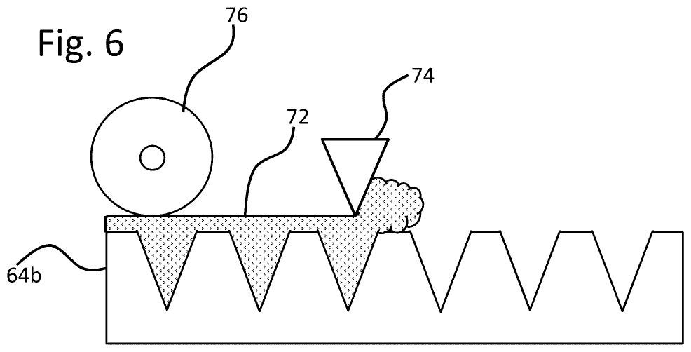

FIG. 5 shows the application of molten glass electrolyte 72 to the surface of the sintered preformed cathode. Molten glass 72 flows into surface cavities 70 as illustrated in FIG. 6. The thickness of the coating may be controlled by a doctor blade casting processor by an extrusion die or by other suitable techniques. Roller 76 smooths and cools/quenches the coating to form the solid glass electrolyte layer. The solid glass electrolyte layer is rapidly cooled from its melting temperature to below its glass transition temperature. The molten glass electrolyte may be, for example and without limitation, lithium metaborate, lithium metaborate doped lithium carbonate (LiBO₂—Li₂CO₃), lithium fluoride doped lithium metaborate, lithium tetraborate, silicon doped lithium tetraborate, lithium orthoborate, lithium orthoborate doped lithium carbonate (Li₃BO₃—Li₂CO₃), lithium fluoride doped Li₃BO₃—Li₂CO₃, lithium sulfate doped Li₃BO₃:Li₂CO₃ (LCBSO), aluminum oxide doped Li₃BO₃:Li₂CO₃:Li₂SO₄ or other similar material. The presently most preferred electrolyte material is LCBSO. The molten glass electrolyte fills the cavities and leaves a separator on the surface of the cathode having a thickness in the range of about 1-50 μm.

### Solid-State Battery Cell

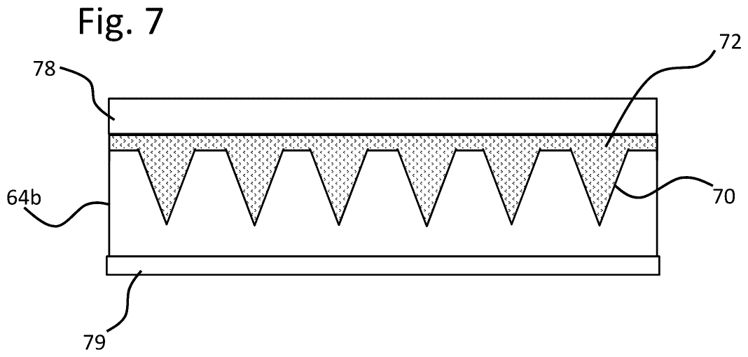

FIG. 7 is a cross section of a final solid-state battery cell according to embodiments of the disclosure. It includes anode layer 78 which is preferably lithium based and may be, without limitation, pure lithium, a lithium alloy or a lithium intercalation material. The anode may be deposited by evaporation or sputter deposition using methods which are known in the art. Cathode current collector 79, which may be a metal such as aluminum, nickel, etc., may also be applied by physical deposition. Alternatively, cathode material 64b may be cast upon current collector 79 as a substrate that remains with it through completion of the resulting cell. In such a scenario, the current collector may be coated with an oxidation resistive coating (such as gold cobalt, an alloy that has the desired properties) or treated by other means to maintain electronic conductivity through the high temperature sintering process.

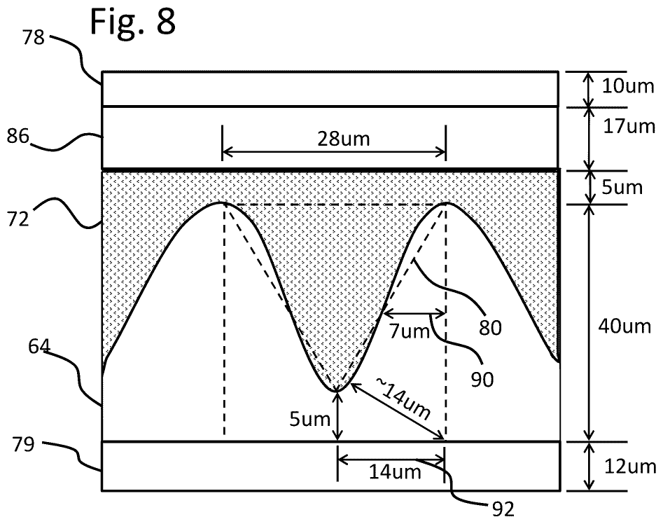

FIG. 8 is a close-up diagram of a cavity 70 filled with electrolyte. The cavity is shown having rounded peaks and valleys, as would result from a chemical machining process for fabrication of the desired die/mold configuration. However, the dimension can be approximated using straight surfaces as represented by conical shapes 80. Test data indicates that the lithium diffusion rates within cathode materials such as those previously discussed herein is such that cathode thicknesses in the range of 7 μm to 14 μm can be accessed at useful discharge/charge rates. The dimensions shown in FIG. 8 are representative of a useful cross-sectional geometry of a full cell according to the present disclosure. The anode (preferably lithium, silicon, lithium alloy, etc.) 86 of the cell has a thickness of 17 μum. The volume of electrolyte filled conical cavity 10 that has a base diameter of 28 μm and a height of 35 μm has a volume of 7,184 μm³. The mid-radius 90 of the cathode is 7 μm while the radius 92 of the base of the cathode is 14 μm.

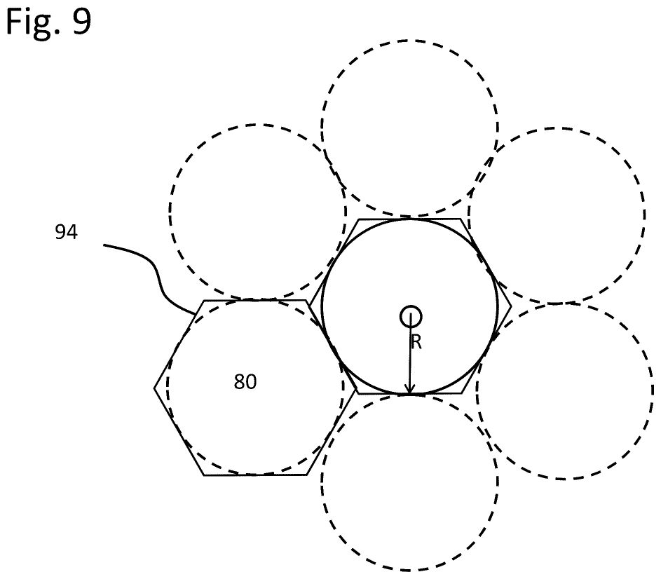

FIG. 9 shows one possible arrangement pattern of the cones as a hexagonal array with hexagon unit cells 94 being concentric with cones 80. It can be shown that the length of the sides of a hexagon is 16 μm if the sides are tangent to a circle of radius 14 μm (R). For the six triangles having base length 16 μm and height 14 μm, the area is 672 μm². Multiplying the area by the 40 μm height of the hexagonal prism yields a volume of 26,880 μm³. Referring back to FIG. 8, the volume of the active material within each hexagonal prism is 19,696 μm³, the volume of the hexagonal prism minus the volume to the electrolyte cone. The geometry meets the constraint of having a diffusion length of 14 μm or less within the active sintered metal oxide. The Am-hour capacity a high-performance cathode active material such as LiNiMnCO₂ is about 1×10⁻⁴Ah/(μm·cm²) or (1×10⁻¹² Ah/μm³). For 19,696 μm³ of active material, the capacity is about 1.97×10⁻⁸ Ah, (1×10⁻¹² Ah/μm³×19,696 μm³). This capacity is used to determine the anode thickness needed to accommodate lithium when the cell is in a fully charged state. The capacity of lithium is 200μAh/μm·cm², (2×10⁻¹² Ah/μm³). To accommodate the 1.97×10⁻⁸ Ah of capacity within the 672 μm² area footprint, the required thickness of the anode is ˜15 μm, (1.97×10⁻⁸ Ah/(2×10⁻¹² Ah/μm³×672 μm²)). Using a mean operating voltage of 3.9 Volts, the energy density is calculated using the total volume of within the hexagonal prism footprint, including the thicknesses of all of the component layers, cathode current collector, the active cathode material/electrolyte composite layer, the electrolyte separator layer, the thickness required for anode at full charge and the anode current collector thickness. The energy density is 1.36 Wh/cm³, [(1.97×10⁻⁸ Ah×3.9V)/(84×10⁻⁴×672×10⁻⁸)cm³]. Similarly, LiCoO₂ has a capacity of 0.72×10⁻⁴ Ah/μm·cm². Its energy density for this geometry would be 0.98 Wh/cm³.

The invention will now be described in connection with the following, non-limiting examples.

### Example 1: Preparation and Analysis of Perforated Sintered Solid-State Battery NCM Cathode

A mixture was prepared by high energy milling 4 g (61%) NCM active cathode material powder (commercially obtained from BASF), 2.4 g (36 wt %) nano-sized (<0.3 μm average particle size) LLZO electrolyte (commercially obtained from MSE Supplies LLC), and 0.2 g (3 wt %) polymer binder (PVB) (commercially obtained from The Tapecasting Warehouse Inc.) with 1.5 ml of ethanol and 1.5 ml of xylene solvents. The mixture was then cast onto a metal foil and allowed to dry. The casting was calendared into a dense sheet.

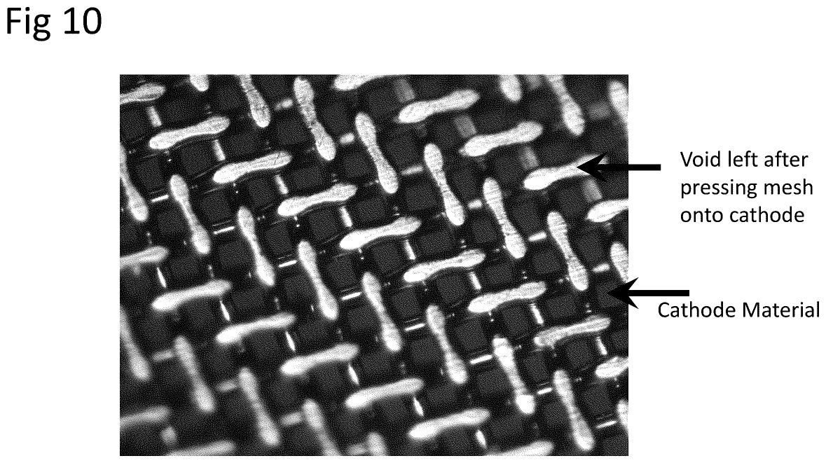

A porous stainless-steel mesh of size 635 mesh was pressed into the green cathode tape and later removed, leaving a perforated cathode having the negative pattern of the mesh, as shown in the optical microscopic image in FIG. 10.

An LLZO slurry was prepared by mixing nano-LLZO powder, approximately 25 nm diameter, with 0.28 g 7 wt % polymer binder (PVB) and 1.6 ml of ethanol and 1.6 ml of xylene solvents. The resulting slurry was doctor blade cast on top of the perforated cathode and allowed to dry. The casting was calendared into a dense sheet using steel rollers. The final thickness of the cathode ranged from 20 to 30 μm.

The cathode was heated at 400° C. in a tube furnace under purging oxygen gas to remove the binder and then at 550° C. in a tube furnace under purging oxygen gas for 1 hour to obtain a porous, sintered, cathode.

Lithium ortho-borate precursor was prepared by mixing 14.7 g of lithium tetraborate with 22 g lithium peroxide powder, both commercially obtained from Sigma Aldrich. LCBSO was prepared by mixing 5 g of lithium ortho borate with 20 g of lithium sulphate, commercially obtained from Sigma Aldrich, with 13.8 g of lithium carbonate, commercially obtained from Sigma Aldrich. A slurry was formed by mixing 0.2 g Li₃BO₃:Li₂CO₃:Li₂SO₄ (LCBSO) with 2 g of isopropanol solvent. After sintering, a slurry of low melt temperature electrolyte was cast onto one surface of the cathode disc. Evaporation of the solvent from the casting left a dry powder coating of Li₃BO₃:Li₂CO₃:Li₂SO₄ on the cathode surface. Next, the cathode was placed inside an oven at 700° C. to reflow the Li₃BO₃:Li₂CO₃:Li₂SO₄, allowing it to migrate into the cathode under capillary force.

Subsequently, a LiPON separator material having a thickness of about 2.5 microns was reactively RF magnetron sputtered onto the surface of the cathode from a lithium phosphate target (commercially obtained from Kurt Lesker) in a nitrogen environment. Finally, a Li metal anode (commercially obtained from Alfa Aesar) was deposited on the LiPON by thermal evaporation in vacuum. The resulting cell was tested using a Maccor battery cycler to obtain the data shown in Table 1, first row.

TABLE 1
Properties of Perforated and Non-Perforated Cathodes

| | | Avg | Discharge | 1st | |
|---|---|---|---|---|---|
| | Resistance | Voltage | (mAh/ | cycle | C- |
| Sample Description | (Ω*cm²) | (V) | cm²) | loss (%) | Rate |
| NCM 111 perforated | 1136 | 3.67 | 386 | 19% | 10 |
| voids filled with | | | | | |
| LLZO | | | | | |
| NCM 111 perforated | 1769 | 3.60 | 461 | 20% | 11 |
| voids filled with | | | | | |
| LCBSO | | | | | |
| NCM 111 no | 1288 | 3.61 | 500 | 22% | 16 |
| perforation | | | | | |

As shown in Table 1, the perforated cathode that is filled with LLZO has an increased c-rate compared to the cathode without any perforation. This is as a result of the reduced tortuosity of the electrolyte in the cathode, allowing continuity throughout the cathode thickness, increasing access of the cathode active material. As clearly shown in Table 1, Example 1, the perforated cathode design outperforms the non-perforated cathode when LLZO was used to infiltrate the voids.

### Example 2: Preparation and Analysis of Perforated Sintered Solid-State Battery NCM Cathode

A mixture was prepared by high energy milling 4 g (61%) NCM active cathode material powder (commercially obtained from BASF), 2.4 g (36 wt %) nano-sized (<0.3 μm average particle size) LLZO electrolyte (commercially obtained from MSE Supplies LLC), and 0.2 g (3 wt %) polymer binder (PVB) (commercially obtained from The Tapecasting Warehouse Inc) with 1.5 ml of ethanol and 1.5 ml of xylene solvents. The mixture was then cast onto a metal foil and allowed to dry. The casting was calendared into a dense sheet.

A porous stainless-steel mesh of size 635 mesh was pressed into the green cathode tape and later removed, leaving a perforated cathode having the negative pattern of the mesh, as shown in the optical microscopic image in FIG. 10.

A LCBSO slurry was prepared by mixing 4 g nano-LCBSO powder (approximately 25 nm diameter) with 0.28 g 7 wt % polymer binder (PVB) and 1.6 ml of ethanol and 1.6 ml of xylene solvents. The resulting slurry was doctor blade cast on top of the perforated cathode and allowed to dry in air. The casting was calendared into a dense sheet using steel rollers. The final thickness of the cathode ranged from 20 to 30 μm.

The cathode was heated at 400° C. in a tube furnace under purging oxygen gas to remove the binder and then at 550° C. in a tube furnace under purging oxygen gas for 1 hour to obtain a porous, sintered, cathode.

After sintering, a slurry of low melt temperature electrolyte was cast onto one surface of the cathode disc. The slurry was formed by mixing 0.2 g Li₃BO₃:Li₂CO₃:Li₂SO₄ (LCBSO) as described with 2 g of isopropanol solvent. Evaporation of the solvent from the casting left a dry powder coating of Li₃BO₃:Li₂CO₃:Li₂SO₄ on the cathode surface. Next, the cathode was placed inside an oven at 700° C. to reflow the Li₃BO₃:Li₂CO₃:Li₂SO₄, allowing it to migrate into the cathode under capillary force.

Subsequently, a LiPON separator material was reactively RF magnetron sputtered from lithium phosphate target (commercially obtained from Kurt Lesker) in a nitrogen environment having a thickness of about 2.5 microns was deposited onto the surface of the cathode by. Finally, a Li metal anode (commercially obtained from Alfa Aesar) was deposited on the LiPON by thermal evaporation in vacuum. The resulting cell was tested using a Maccor battery cycler to obtain the data shown in Table 1, second row.

As can be seen in Table 1, a perforated cathode that is filled with LCBSO had an increased C-rate compared to the cathode without any perforation. This is as a result of the reduced tortuosity of the electrolyte in the cathode, allowing continuity throughout the cathode thickness, increasing access of the cathode active material. It is clearly shown in Table 1 that the perforated cathode design outperforms the non-perforated cathode, regardless of the electrolyte choice for infiltrating the voids.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A solid-state battery cell comprising:
a sintered metal oxide cathode, wherein a surface of the cathode has an array of micro machined cavities extending about 60-90% into a depth of the cathode;
a glass or glass ceramic electrolyte separator forming a flat smooth layer on the cathode surface and extending into the depths of the micro-machined cavities of the cathode; and
a lithium-based anode, wherein the anode is in contact with the electrolyte on a side opposite the cathode.

2. The solid-state battery cell according to claim 1, wherein the cathode comprises an inorganic lithium oxide ceramic material.

3. The solid-state battery cell according to claim 2, wherein the cathode comprises lithium nickel manganese cobalt oxide (NCM), lithium titanium oxide (LTO), Lithium Nickel Oxide (LNO), lithium cobalt oxide (LCO), or lithium manganese oxide (LMO).

4. The solid-state battery cell according to claim 1, wherein the cathode has a thickness of about 10 to about 200 microns.

5. The solid-state battery cell according to claim 1, wherein the cavities have a conical, triangular, semi-circular, or rectangular shape.

6. The solid-state battery cell according to claim 1, wherein the flat layer of the glass or glass ceramic electrolyte separator has a thickness of about 1-50 μm.

7. The solid-state battery cell according to claim 1, wherein the glass or glass ceramic electrolyte on the cathode surface is applied to the cathode in a molten state and flows into the cavities before solidifying.

8. The solid-state battery cell according to claim 1, wherein the glass or glass ceramic electrolyte comprises at least one of lithium metaborate, lithium metaborate doped lithium carbonate (LiBO₂—Li₂CO₃), lithium fluoride doped lithium metaborate, lithium tetraborate, silicon doped lithium tetraborate, lithium orthoborate, lithium orthoborate doped lithium carbonate (Li₃BO₃—Li₂CO₃), lithium fluoride doped Li₃BO₃—Li₂CO₃, lithium sulfate doped Li₃BO₃:Li₂CO₃ (LCBSO), and aluminum oxide doped Li₃BO₃:Li₂CO₃:Li₂SO₄.

9. The solid-state battery cell according to claim 1, wherein the lithium-based anode is a lithium anode and wherein the solid-state battery cell further comprises a cathode current collector.

10. A solid-state battery cell comprising a non-homogeneous mixture of cathode active material and glass or glass ceramic electrolyte material, wherein a continuous electrolyte separator extends into cavities of a patterned cathode, providing high surface area interface.

11. The solid-state battery cell according to claim 10, wherein the cathode comprises an inorganic lithium oxide ceramic material.

12. The solid-state battery cell according to claim 11, wherein the cathode comprises lithium nickel manganese cobalt oxide (NCM), lithium titanium oxide (LTO), Lithium Nickel Oxide (LNO), lithium cobalt oxide (LCO), or lithium manganese oxide (LMO).

13. The solid-state battery cell according to claim 10, wherein the cathode has a thickness of about 10 to about 200 microns.

14. The solid-state battery cell according to claim 10, wherein the cavities have a conical, triangular, semi-circular, or rectangular shape.

15. The solid-state battery cell according to claim 10, wherein the layer of the glass or glass ceramic electrolyte separator has a thickness of about 1-50 μm.

16. The solid-state battery cell according to claim 10, wherein the glass or glass ceramic electrolyte is applied to the cathode in a molten state and flows into the cavities before solidifying.

17. The solid-state battery cell according to claim 10, wherein the glass or glass ceramic electrolyte comprises at least one of lithium metaborate, lithium metaborate doped lithium carbonate (LiBO₂—Li₂CO₃), lithium fluoride doped lithium metaborate, lithium tetraborate, silicon doped lithium tetraborate, lithium orthoborate, lithium orthoborate doped lithium carbonate (Li₃BO₃—Li₂CO₃), lithium fluoride doped Li₃BO₃—Li₂CO₃, lithium sulfate doped Li₃BO₃:Li₂CO₃ (LCBSO), and aluminum oxide doped Li₃BO₃:Li₂CO₃:Li₂SO₄.

18. A method for making a solid-state battery cell comprising:
(a) providing a cathode slurry comprising a cathode active material and a solvent;
(b) slurry casing the cathode slurry onto a non-stick substrate to form a green ceramic cathode material;
(c) printing a pattern into a surface of the cathode to produce cavities in the surface;
(d) sintering the patterned cathode to form a solid ceramic cathode;
(e) coating the printed surface of the cathode with a layer of molten glass or glass ceramic electrolyte; and
(f) quenching the molten glass or glass ceramic electrolyte to form a dense cathode-separator composite structure comprising a continuous separator extending into the cavities of the patterned cathode.

19. The method according to claim 18, wherein the sintering step (d) comprises heating the cathode at a temperature of about 500° C. to about 900° C.

20. The method according to claim 18, wherein the cathode active material comprises an inorganic lithium oxide ceramic material.

21. The method according to claim 21, wherein the cathode active material comprises lithium nickel manganese cobalt oxide (NCM), lithium titanium oxide (LTO), Lithium Nickel Oxide (LNO), lithium cobalt oxide (LCO), or lithium manganese oxide (LMO).

22. The method according to claim 18, wherein the solid ceramic cathode has a thickness of about 10 to about 200 microns.

23. The method according to claim 18, wherein the cavities have a conical, triangular, semi-circular, or rectangular shape.

24. The method according to claim 18, wherein the layer of the glass or glass ceramic electrolyte separator has a thickness of about 1-50 μm.

25. The method according to claim 18, wherein the glass or glass ceramic electrolyte comprises at least one of lithium metaborate, lithium metaborate doped lithium carbonate (LiBO₂—Li₂CO₃), lithium fluoride doped lithium metaborate, lithium tetraborate, silicon doped lithium tetraborate, lithium orthoborate, lithium orthoborate doped lithium carbonate (Li₃BO₃—Li₂CO₃), lithium fluoride doped Li₃BO₃—Li₂CO₃, lithium sulfate doped Li₃BO₃:Li₂CO₃ (LCBSO), and aluminum oxide doped Li₃BO₃:Li₂CO₃:Li₂SO₄.

26. The method according to claim 18, further comprising (g) depositing a lithium anode on the separator.

27. The method according to claim 26, further comprising (h) depositing a cathode current collector on the lithium anode.
